(19) United States
(12) Patent Application Publication
(10) Pub. No.: US 2007/0228216 A1
(43) Pub. Date: Oct. 4, 2007

(54) GALLEY ASSEMBLY FOR AN AIRCRAFT

(75) Inventor: Christopher John Wenstrom, Wokingham (GB)

Correspondence Address: ADAMS EVANS P.A., Suite 2350 Charlotte Plaza, 201 South College Street, CHARLOTTE, NC, 28244, US

(73) Assignee: BE AEROSPACE, INC., Wellington, FL (US)

(21) Appl. No.: 11/693,012

(22) Filed: Mar. 29, 2007

Related U.S. Application Data
(60) Provisional application No. 60/744,148, filed on Apr. 3, 2006.

(51) Int. Cl. B64D 11/00

(52) U.S. Cl. 244/118.5

(57) ABSTRACT

A galley assembly includes a plurality of modules including adjacent panels mounted to a floor by a plurality of floor fittings and interconnected by a monolithic connector block. The panels are formed by a core disposed between a pair of spaced-apart skins. One of the modules includes a horizontal worktop formed by a substantially rigid bottom panel, a top skin and a perimeter frame disposed between the bottom panel and the top skin. Each floor fitting includes a floor fitting block attached to a bottom edge of the panel and a floor mount attached to the floor fitting block that carries a stud for engaging a floor track in the floor. The connector block includes a main body having a joint face and a peripheral flange, a work opening formed in the main body and a fastener hole formed through the joint face and in communication with the work opening.

### CROSS REFERENCE TO RELATED APPLICATIONS

This application claims the benefit of U.S. Provisional Application No. 60/744,148 filed Apr. 3, 2006.

### BACKGROUND OF THE INVENTION

This invention relates generally to aircraft interior equipment, and more particularly, to a galley assembly for an aircraft.

Commercial passenger aircraft often include galleys for food preparation. Galleys incorporate features such as storage areas, ovens, sinks, coffee makers, and the like, and are usually built up from individual panels, commonly referred to as modules. It is desirable for the modules to be easily and readily interconnected and for at least one of the modules to include a floor fitting for mounting the galley to a floor of an aircraft that forms an effective seal between the galley and the floor.

### BRIEF SUMMARY OF THE INVENTION

This present invention provides a number of features for constructing a galley with a low part count and reduced cost. A particular object of the invention is to provide a galley including at least one module having a horizontal worktop that defines a working surface and a perimeter around the working surface having a raised lip. Another object of the present invention is to provide a galley including a plurality of modules that can be easily and readily interconnected. Another object of the invention is to provide at least one module for a galley including a floor fitting for mounting the galley to a floor of an aircraft that forms an effective seal between the galley and the floor.

In one aspect, the present invention provides a galley assembly including a plurality of interconnected modules. Each module includes at least one panel formed by a core disposed between a pair of spaced-apart skins. At least one of the modules includes a panel disposed horizontally to form a work deck that supports a worktop. The worktop includes a substantially rigid bottom panel, a top skin and a perimeter frame disposed between the bottom panel and the top skin. In one embodiment, the top skin defines a working surface and a raised lip forming a perimeter around the working surface. The perimeter frame has a central opening and is disposed between the bottom panel and the raised lip of the top skin to provide structural support for the raised lip.

In other embodiments, the galley assembly further includes a plurality of floor fittings for mounting the galley assembly to a floor. Each floor fitting includes a floor fitting block attached to the panel adjacent a bottom edge of the panel and a floor mount attached to the floor fitting block. The floor mount carries at least one stud for engaging a floor track in the floor to secure the galley assembly to the floor. A pocket is formed in the panel through one of the skins and the core, and the pocket contains an insert for receiving a fastener to secure the floor fitting block to the panel.

In still other embodiments, the galley assembly further includes a monolithic connector block for interconnecting adjacent panels. The connector block includes a main body having a joint face and a peripheral flange, a work opening formed in the main body and a fastener hole formed through the joint face and in communication with the work opening. The connector block is bonded into a recess formed in one of the adjacent panels using an adhesive and the connector block is positioned such that the joint face is flush with an edge of the panel and the peripheral flange lies next to one of the panel skins.

In another aspect, the present invention provides a galley assembly including a plurality of interconnected modules wherein each module includes at least one panel. The galley assembly further includes a plurality of floor fittings for mounting the galley assembly to a floor. Each floor fitting includes a floor fitting block attached to the panel adjacent a bottom edge of the panel and a floor mount attached to the floor fitting block. The floor mount carries at least one stud for engaging a floor track in the floor to secure the galley assembly to the floor.

In other embodiments, the panel is formed by a core disposed between a pair of spaced-apart skins and a pocket is formed in the panel through one of the skins and the core. The pocket contains an insert for receiving a fastener to secure the floor fitting block to the panel. Preferably, the insert is bonded into the pocket of the panel using an adhesive and the insert is internally threaded to receive an externally threaded fastener.

In still other embodiments, the galley further includes a floor fitting cover attached to an outer surface of the floor fitting block and an elongated end cap secured to the panel. The end cap has a slot formed therein to accommodate the floor fitting block. An elongated seal retainer is attached to the end cap and the seal retainer carries a seal that bears against the floor. Preferably, the seal has an L-shaped cross-section which defines a groove with the seal retainer.

In yet another aspect, the present invention provides a galley assembly including a plurality of interconnected modules wherein each module includes at least one panel. The galley assembly further includes a monolithic connector block for interconnecting adjacent panels. The connector block includes a main body having a joint face and a peripheral flange, a work opening formed in the main body and a fastener hole formed through the joint face and in communication with the work opening.

In other embodiments, the panel is formed by a core disposed between a pair of spaced-apart skins and the connector block is bonded into a recess formed in one of the adjacent panels using an adhesive. The connector block is positioned such that the joint face is flush with an edge of the panel and the peripheral flange lies next to one of the panel skins. A fastener is inserted into the work opening and through the fastener hole of the connector block, and subsequently into the other of the adjacent panels to interconnect the adjacent panels.

### BRIEF DESCRIPTION OF THE DRAWINGS

The subject matter that is regarded as the invention may be best understood by reference to the following description taken in conjunction with the accompanying drawing figures in which:

FIG. 1 is a front perspective view of a galley assembly constructed in accordance with the present invention;

FIG. 2 is a front perspective view of the galley of FIG. 1 exploded into several individual modules;

FIG. 3 is another exploded perspective view of the galley assembly of FIG. 1;

FIG. 4 is a perspective view of a worktop for a galley assembly according to the present invention;

FIG. 5 is an exploded perspective view of the worktop shown in FIG. 4;

FIG. 6 is an perspective view of a floor fitting arrangement for a galley assembly according to the present invention;

FIG. 7 is an exploded perspective view of the floor fitting arrangement shown in FIG. 6;

FIG. 8 is a cross-sectional view of a portion of a panel of one of the modules of the galley assembly showing an insert disposed therein;

FIG. 9A is a rear perspective view of one of the modules of the galley assembly;

FIG. 9B is a front perspective view of the module shown in FIG. 9A;

FIG. 10 is a perspective view of a connector block for use with a galley assembly according to the present invention; and

FIG. 11 is a cross-sectional view of the connector block shown in FIG. 10 disposed in a panel of the galley assembly.

### DETAILED DESCRIPTION OF THE INVENTION

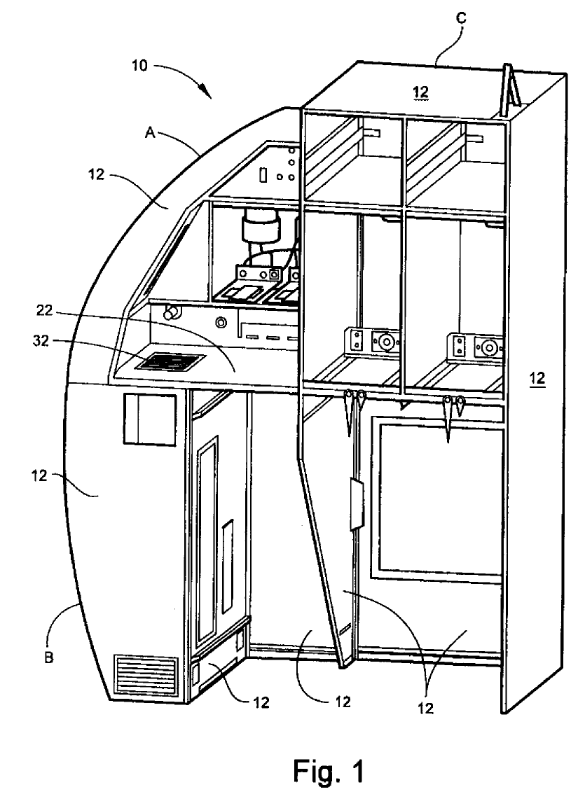

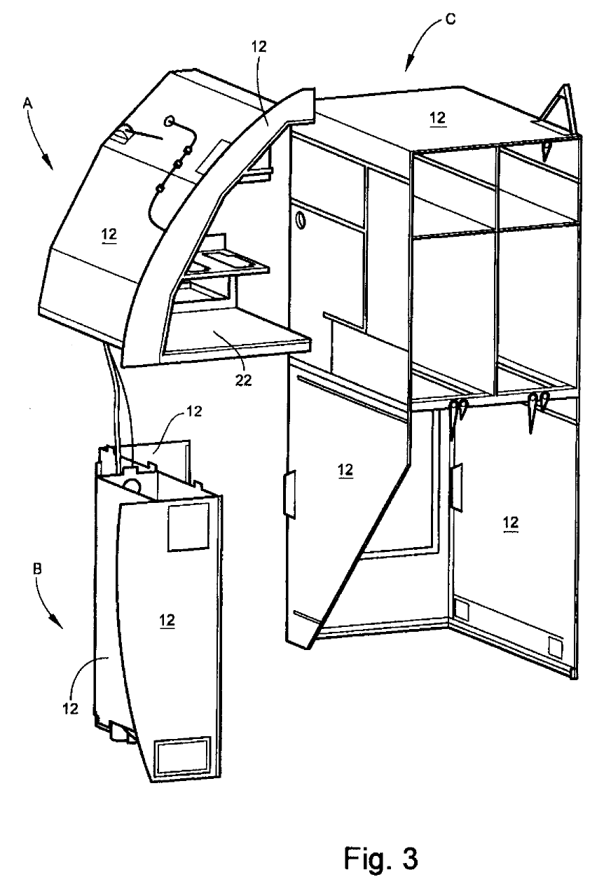

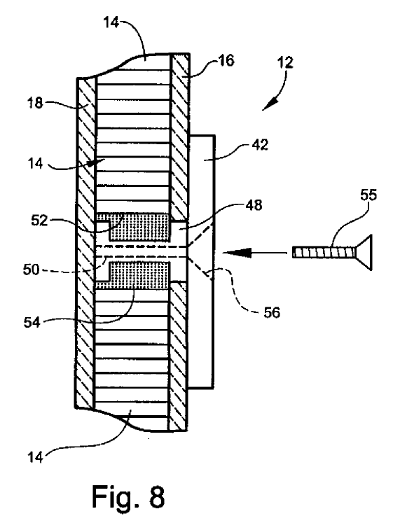

Referring to the drawings wherein identical reference numerals denote the same elements throughout the various views, a galley assembly 10 for an aircraft is illustrated in FIGS. 1-3. However, a galley assembly according to the present invention is equally applicable for use in other kinds of vehicles, for example trains, and is also applicable to the construction of other types of interior appointments. The galley assembly 10 is built up from a number of structural modules each comprising panels 12 which are connected together in a suitable manner, for example using mechanical fasteners or adhesives, but more preferably, using the connector block 68 shown and described hereinafter. The panels 12 are arranged to form functional modules, labeled “A”, “B”, and “C” in the drawing figures. In the embodiments shown and described herein, each of the panels 12 has a honeycomb cellular core 14, with skins 16 and 18 bonded to opposite faces thereof (see FIG. 8). Non-limiting examples of suitable materials for both the core 14 and the skins 16 and 18 include phenolic resin, nomex, and aluminum. The panels 12 are then formed, for example by machining, into desired shapes and sizes. The exposed edges of the panels 12 may be “capped” with trim moldings in a known manner to present a neat appearance.

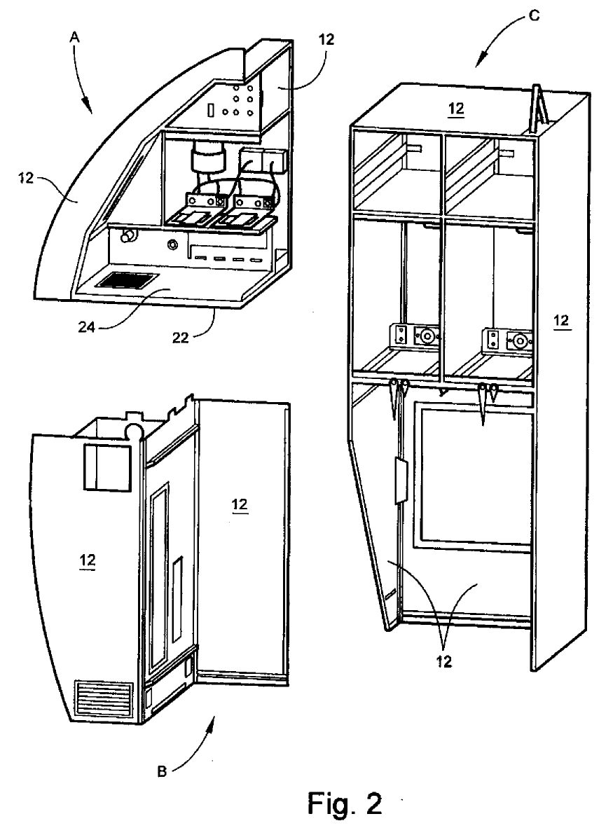

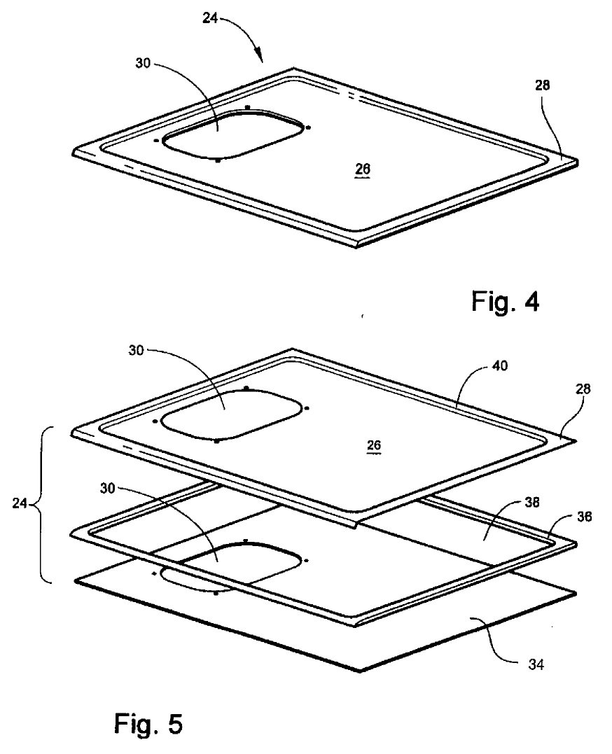

One of the panels 12 is disposed horizontally to form a workdeck 22. The workdeck 22 covers the interior of module A the galley assembly 10 and also supports a working surface 26 for storage or food preparation. As shown in FIG. 2, a worktop 24 is disposed on top of the workdeck 22. The worktop 24 has an upper working surface 26 (as shown in FIG. 4), preferably with a raised lip 28 around its perimeter, and a sink opening 30 passing therethrough. The worktop 24 may be secured to the workdeck 22 only by a sink 32 (see FIG. 1) and its associated fasteners, and additional fasteners, as required.

FIG. 5 illustrates the worktop 24 in more detail. The worktop 24 has a rigid bottom panel 34 which generally matches the shape and size of the workdeck 22. An upstanding perimeter frame 36 with a central opening 38 is attached to the upper surface of the bottom panel 34, for example using mechanical fasteners or an adhesive. A top skin 40 defining working surface 26 is disposed on top of the perimeter frame 36 and the bottom panel 34. The top skin 40 is relatively thin and has an offset edge which defines the raised lip 28 described above. The presence of the perimeter frame 36 provides structural support for the raised lip 28. The top skin 40 may be made of a material which is sanitary and easily cleaned, such as plastic, stainless steel, aluminum, etc.

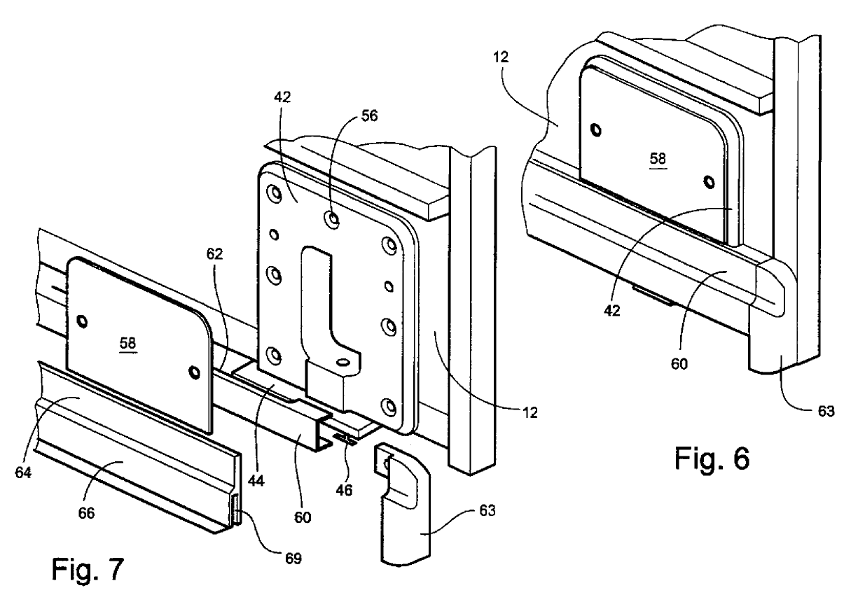

FIGS. 6-8 illustrate how the galley assembly 10 may be mounted to a floor of an aircraft. A number of floor fitting blocks 42 are attached to the panels 12 near their bottom edges. A floor mount 44 which carries mushroom-headed studs 46 is attached to the floor fitting block 42. The studs 46 engage floor tracks (not shown) of a known type in order to secure the galley assembly 10 to the floor. In the example shown in FIG. 8, a number of rigid inserts 48 with internally threaded bores 50 are “potted” into the panel 12. That is, a pocket 52 is formed in the panel 12 through one of the skins 16 and the core 14. The insert 48 is then bonded into the panel 12 using a suitable adhesive 54 which fills the gap between the pocket 52 and the insert 48. Screws 55 or other suitable fasteners are then driven through holes 56 in the floor fitting block 42 and fastened (i.e. threaded) into the bores 50.

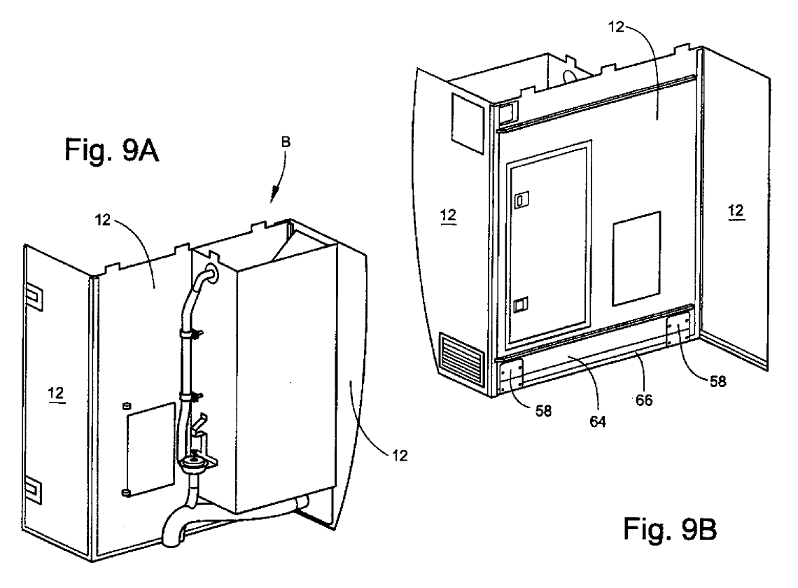

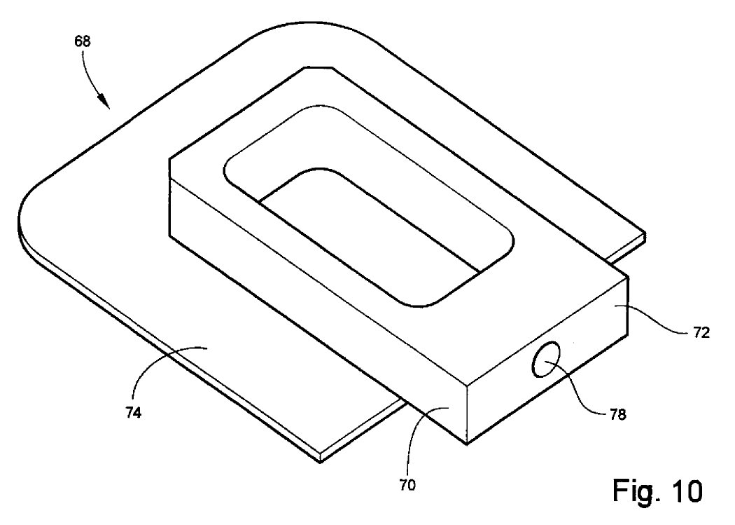

A floor fitting cover 58 is attached to the outer surface of the floor fitting block 42 and serves to prevent leakage and provides a pleasing appearance. An elongated end cap 60, which may be an extrusion of aluminum or the like, is secured to the panel 12, and includes a slot 62 formed therein to accommodate the floor fitting block 42. The end cap 60 may be closed at one or both ends by an end post 63. An elongated seal retainer 64 is attached to the end cap 60, and carries a seal 66 which bears against the floor of the aircraft. In this particular example, the seal 66 has an L-shaped cross-section, one leg of which defines a groove 69 with the seal retainer 64. When fully assembled, as shown in FIG. 7, fluids and debris are prevented from leaking from one side of the panel 12 to the other, and are also blocked from leaking down into the working parts of the floor mount 44. FIGS. 9A and 9B show the front and the rear, respectively, of the module B of the galley assembly 10. FIG. 9B illustrates the floor fitting cover 58, the seal retainer 64 and the seal 66 affixed to the lower portion of one of the panels 12.

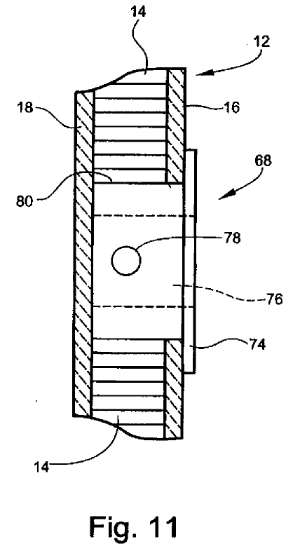

The various panels 12 (and the modules A, B, and C) of the galley assembly 10 are connected together to provide a rigid structure, typically using adhesives and/or mechanical fasteners. In order to use mechanical fasteners in the composite panels 12, solid attachment points must be provided and the fastener loads must be spread out. In prior art galleys, this is done by providing a block inlet into the panel 12, and also one or more sheet-like doublers. This configuration requires multiple parts and assembly steps. In the embodiments of the galley assembly 10 illustrated herein, a single connector block 68 (see FIG. 9) is provided at each location where an edge-to edge joint is needed between adjacent panels 12. As shown in FIGS. 10 and 11, the connector block 68 is a monolithic structure (formed by casting, forging, machining, etc.) comprising a main body 70 with a joint face 72, and a peripheral flange 74. A work opening 76 is formed in the main body 70, and a fastener hole 78 passes through the joint face 72, and communicates with the work opening 76.

The connector block 68 is bonded into a recess 80 formed in the panel 12, for example using an adhesive. The connector block 68 is positioned such that the joint face 72 is flush with the edge of the panel 12 that contacts the adjacent panel 12, or with the molding that seals the edge of the panel. The peripheral flange 74 lies next to one of the panel skins 16 and serves to reinforce the panel 12 without the use of a separate doubler. Once the connector block 68 is installed, a fastener such as a bolt or machine screw (not shown) may be inserted into the work opening 76 and through the fastener hole 78, and subsequently threaded into an adjacent panel 12.

The foregoing has described a galley assembly with a low part count and reduced cost. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A galley assembly comprising:
a plurality of interconnected modules, each module including at least one panel comprising a core disposed between a pair of spaced-apart skins, at least one of the modules comprising a panel disposed horizontally to form a work deck that supports a worktop, the worktop comprising a substantially rigid bottom panel, a top skin and a perimeter frame disposed between the bottom panel and the top skin.

2. The galley assembly of claim 1, wherein the top skin defines a working surface and a raised lip forming a perimeter around the working surface, and wherein the perimeter frame has a central opening and is disposed between the bottom panel and the raised lip of the top skin to provide structural support for the raised lip.

3. The galley assembly of claim 1, further comprising a plurality of floor fittings for mounting the galley assembly to a floor, each floor fitting comprising a floor fitting block attached to the panel adjacent a bottom edge of the panel and a floor mount attached to the floor fitting block, the floor mount carrying at least one stud for engaging a floor track in the floor to secure the galley assembly to the floor.

4. The galley assembly of claim 3, wherein a pocket is formed in the panel through one of the skins and the core, the pocket containing an insert for receiving a fastener to secure the floor fitting block to the panel.

5. The galley assembly of claim 1, further comprising a monolithic connector block for interconnecting adjacent panels, the connector block comprising a main body having a joint face and a peripheral flange, a work opening being formed in the main body and a fastener hole being formed through the joint face and in communication with the work opening.

6. The galley assembly of claim 5, wherein the connector block is bonded into a recess formed in one of the adjacent panels using an adhesive and the connector block is positioned such that the joint face is flush with an edge of the panel and the peripheral flange lies next to one of the panel skins.

7. A galley assembly comprising:
a plurality of interconnected modules, each module comprising at least one panel; and
a plurality of floor fittings for mounting the galley assembly to a floor, each floor fitting comprising a floor fitting block attached to the panel adjacent a bottom edge of the panel and a floor mount attached to the floor fitting block, the floor mount carrying at least one stud for engaging a floor track in the floor to secure the galley assembly to the floor.

8. The galley assembly of claim 7, wherein the panel comprises a core disposed between a pair of spaced-apart skins and wherein a pocket is formed in the panel through one of the skins and the core, the pocket containing an insert for receiving a fastener to secure the floor fitting block to the panel.

9. The galley assembly of claim 8, wherein the insert is bonded into the pocket of the panel using an adhesive and the insert is internally threaded.

10. The galley assembly of claim 7, further comprising a floor fitting cover attached to an outer surface of the floor fitting block and an elongated end cap secured to the panel, the end cap having a slot formed therein to accommodate the floor fitting block.

11. The galley assembly of claim 10, further comprising an elongated seal retainer attached to the end cap, the seal retainer carrying a seal that bears against the floor.

12. The galley assembly of claim 11, wherein the seal has an L-shaped cross-section which defines a groove with the seal retainer.

13. The galley assembly of claim 7, further comprising a monolithic connector block for interconnecting adjacent panels, the connector block comprising a main body having a joint face and a peripheral flange, a work opening being formed in the main body and a fastener hole being formed through the joint face and in communication with the work opening.

14. The galley assembly of claim 13, wherein the connector block is bonded into a recess formed in one of the adjacent panels using an adhesive and the connector block is positioned such that the joint face is flush with an edge of the panel and the peripheral flange lies next to one of the panel skins.

15. The galley assembly of claim 14, wherein a fastener is inserted into the work opening and through the fastener hole of the connector block and subsequently into the other of the adjacent panel to interconnect the adjacent panels.

16. A galley assembly comprising:
a plurality of interconnected modules, each module comprising at least one panel; and
a monolithic connector block for interconnecting adjacent panels, the connector block comprising a main body having a joint face and a peripheral flange, a work opening being formed in the main body and a fastener hole being formed through the joint face and in communication with the work opening.

17. The galley assembly of claim 16, wherein the panel comprises a core disposed between a pair of spaced-apart skins and wherein the connector block is bonded into a recess formed in one of the adjacent panels using an adhesive and the connector block is positioned such that the joint face is flush with an edge of the panel and the peripheral flange lies next to one of the panel skins.

18. The galley assembly of claim 17, wherein a fastener is inserted into the work opening and through the fastener hole of the connector block and subsequently into the other of the adjacent panel to interconnect the adjacent panels.

19. The galley assembly of claim 16, further comprising a plurality of floor fittings for mounting the galley assembly to a floor, each floor fitting comprising a floor fitting block attached to a panel adjacent a bottom edge of the panel and a floor mount attached to the floor fitting block, the floor mount carrying at least one stud for engaging a floor track in the floor to secure the galley assembly to the floor.

20. The galley assembly of claim 19, wherein the panel comprises a core disposed between a pair of spaced-apart skins and wherein a pocket is formed in the panel through one of the skins and the core, the pocket containing an insert for receiving a fastener to secure the floor fitting block to the panel.
